(19) United States
(12) Patent Application Publication
(10) Pub. No.: US 2016/0098683 A1
(43) Pub. Date: Apr. 7, 2016

(54) SYSTEM AND METHOD FOR JOB AND CAREER DISCOVERY BASED ON USER ATTRIBUTES AND FEEDBACK

(71) Applicant: AfterCollege, Inc., San Francisco, CA (US)

(72) Inventors: Roberto ANGULO, San Francisco, CA (US); Devin KAYLOR, San Francisco, CA (US); Man Chau LEE, San Francisco, CA (US); Stephen GIROLAMI, San Francisco, CA (US); Teresa TORRES, San Francisco, CA (US)

(21) Appl. No.: 14/504,380

(22) Filed: Oct. 1, 2014

(51) Int. Cl. G06Q 10/10

(52) U.S. Cl. CPC G06Q 10/1053

(57) ABSTRACT

A system and method for identifying career opportunities to a job seeker comprising a first input device used to gather first information from a first job seeker and a processor which is programmed to obtain first priority information from the first job seeker regarding the personal importance of various job characteristics. The system and method may also include a second input device to gather first additional information regarding the first job seeker from at least one other person who has first additional information regarding the first job seeker and wherein the processor is programmed to determine at least two characteristics of the first job seeker from information gathered concerning said the job seeker, The processor may be programmed to determine a relative importance of the at least two characteristics of the first job seeker and the system and method may include a comparator for comparing the desired characteristics of the career choices with characteristics of the first job seeker to identify a possible career choice for said the job seeker and an output device to present the possible career choice to the first job seeker.

### TECHNICAL FIELD

The invention pertains to a system and method for assisting individuals in their search for employment where the identified employment opportunities are not solely based on, or obvious from, their major at school or their previous employment history but are specifically identified through information specific to the individual searching for employment (“the job seeker”) and other similarly situated individuals.

### BACKGROUND OF THE INVENTION

U.S. Pat. No. 7,213,019 (“the '019 Patent”) is directed to, among other things, Career Management Tools which serve as self-contained hubs of activity where employers, alumni, and faculty can post information (such as jobs, research and teaching opportunities, and class projects) and group and department members can connect with employers and alumni at the department or group level. The '019 Patent matches individuals with opportunities and it matches employers with relevant individuals based on their group affiliation such as majors and schools. The Career Management Tool disclosed in the '019 Patent allows a group to easily manage job postings and members' resumes directly from the group's website. That Career Management Tool, creates a group-specific network that provides a reliable long-term network for students, alumni, faculty, and employers and it enhances the career placement services offered by, for example, universities.

### SUMMARY OF THE INVENTION

In one embodiment the present invention includes a method of identifying career opportunities for a first and a second job seeker comprising the steps of gathering desired characteristics common to individuals in at least a first and a second career choice from at least one employer; gathering information concerning individuals currently working in the first career choice and using the information to determine characteristics of individuals in the first career choice; gathering information concerning individuals currently working in the second career choice and using the information to determine characteristics of individuals in the second career choice; gathering first information from the first job seeker; obtaining first priority information from the first job seeker regarding the personal importance of various job characteristics; gathering second information from the second job seeker; obtaining second priority information from the second job seeker regarding the personal importance of various job characteristics; determining at least two characteristics of the first job seeker from information gathered concerning the first job seeker; determining a relative importance of the at least two characteristics of the first job seeker; determining at least two characteristics of the second job seeker from information gathered concerning the second job seeker; determining a relative importance of the at least two characteristics of the second job seeker; storing (a) the first and second career choices, (b) desired characteristics common to individuals in at least the first and second career choices, (c) the first priority information from the first job seeker, and (d) the second priority information from said second job seeker; in a database; searching the database using the at least two characteristics of the first job seeker to identify a possible career choice; and presenting the career choice to the first job seeker.

The present invention may include one or more of the following: (1) calculating a justification for the career choice presented to the first job seeker wherein the justification uses at least first priority information from the first job seeker, information regarding the first job seeker, and the at least two characteristics of the first job seeker; and presenting the justification to the first job seeker to explain how the possible career choice was determined; (2) wherein one of the at least two characteristics of the first job seeker includes an extrapolated job characteristic; (3) wherein one of the at least two characteristics of the first job seeker includes an interpolated job characteristic; (4) wherein the information concerning the first job seeker is on the hobbies of the first job seeker; (5) wherein the information concerning the first job seeker is on the ideal vacation of the first job seeker; (6) wherein the information concerning the first job seeker is on the worst vacation experience reported by the first job seeker; (7) further including gathering first additional information regarding the first job seeker from at least one other person who has first additional information regarding the first job seeker; (8) further including gathering second additional information regarding the second job seeker from at least another individual who has second additional information regarding the second job seeker; (9) further including identifying at least one trend in the first or second career choice and using the trend to identify the possible career choice to the first or second job seeker; (10) further including time sensitive information in the database and using the time sensitive information to identify the possible career choice for the first job seeker. In one embodiment, the time sensitive information is less than 72 hours old.

Another embodiment of the current invention includes a Career Discovery Engine used for identifying career opportunities to a job seeker comprising a first input device to gather first information from a first job seeker; a processor programmed to obtain first priority information from the first job seeker regarding the personal importance of various job characteristics; a second input device to gather first additional information regarding the first job seeker from at least one other person who has first additional information regarding the first job seeker; the processor programmed to determine at least two characteristics of the first job seeker from information gathered concerning the first job seeker; the processor programmed to determine a relative importance of the at least two characteristics of the first job seeker; a comparator for comparing desired characteristics of the career choices with characteristics of the first job seeker to identify a possible career choice for the first job seeker; and an output device to present the possible career choice to the first job seeker. This embodiment may also include where the processor is also programmed to calculate a justification for the possible career choice presented to the first job seeker and the output device is also used to present the justification to the first job seeker to explain how the possible career choice was determined.

Another embodiment of the present invention includes a Career Discovery Engine used for identifying career opportunities to a job seeker comprising a first input device to gather first information from a first job seeker; a processor programmed to obtain first priority information from said first job seeker regarding the personal importance of various job characteristics; a second input device to gather first additional information regarding the first job seeker from at least one other person who has first additional information regarding the first job seeker; the processor programmed to determine at least two characteristics of the first job seeker from information gathered concerning the first job seeker; the processor programmed to determine a relative importance of the at least two characteristics of the first job seeker; a comparator for comparing desired characteristics of the career choices with characteristics of the first job seeker to identify a possible career choice for the first job seeker;

an output device to present the possible career choice to the first job seeker; where the processor is programmed to calculate a justification for the possible career choice presented to the first job seeker wherein the justification uses at least first priority information from the first job seeker, information regarding the first job seeker, and the at least two characteristics of the first job seeker; and wherein the output device to present the justification to the first job seeker is used to explain how the possible career choice was determined.

Another embodiment of the present invention includes a Career Discovery Engine used for identifying career opportunities to a job seeker comprising a first input device to gather first information from a first job seeker; a processor programmed to obtain first priority information from the first job seeker regarding the personal importance of various job characteristics; a second input device to gather first information from a second job seeker who shares at least one characteristic in common with the first job seeker; the processor programmed to obtain first priority information from the second job seeker regarding the personal importance of various job characteristics. A comparator for comparing desired characteristics of the career choices with characteristics of the first job seeker to identify a possible career choice for the first job seeker and for the second job seeker; an output device to present the possible career choice to the first job seeker and second job seeker; where the processor is programmed to calculate a justification for the possible career choice presented to the first job seeker wherein the justification uses at least first priority information from the first job seeker, information regarding the first job seeker, and the at least two characteristics of the first job seeker; and wherein the output device to present the justification to the first job seeker is used to explain how the possible career choice was determined.

### BRIEF DESCRIPTION OF THE DRAWINGS

The drawings are meant to illustrate the principles of the invention and do not limit the scope of the invention. The above-mentioned features and objects of the present disclosure will become more apparent with reference to the following description taken in conjunction with the accompanying drawings wherein like reference numerals denote like elements in which:

FIG. 1 is a high level diagram of one embodiment including the present invention;

FIG. 2 is a flow chart illustrating a representative algorithm that may be used to implement the present invention;

FIG. 3 is a flow chart illustrating a natural language algorithm that may be used to implement the present invention;

FIG. 4 is a flow chart of example inputs into the Career Discovery Engine;

FIG. 5 is a flow chart for the identification of Employment/School Characteristics;

FIG. 6 is a flow chart for the identification of Direct Job Characteristics;

FIG. 7 is a flow chart for the identification of Extrapolated and Interpolated Job Characteristics;

FIG. 8 is a screen capture of an example embodiment of the invention in which the career discovery tool takes user provided characteristics to make job and internship recommendations that are then rated by the user, further improving the recommendations for the user and other similar users in real time; and

FIG. 9 is an example computer system that may be used to implement the present invention.

### DETAILED DESCRIPTION OF THE INVENTION

Many individuals, especially young people, don't have a complete picture of what employment opportunities are available to them, what career choices they are qualified for, what career choices they would enjoy, or what career choices they should seriously consider. We all have preconceived ideas of what opportunities are out there and what they consist of, based on our incomplete knowledge of the world and the industry around us. The same applies for knowledge of companies and organizations where we can pursue a career. In general, we know of well known or large employers such as Google and Apple. We may also be aware of local employers, like the local factory, or bank, or software company, where we may want to pursue a career. However, there's a vast array of employers and career opportunities out there that may be relevant to us that we are not aware of.

The present invention, aims to solve this problem by making young people (or others seeking employment or considering a career change) aware of relevant opportunities available to them based not only on their major and grade point average, but also on inter alia, their school, interests, hobbies, previous enjoyable activities, previous nonenjoyable activities, employment sought or obtained by others with similar majors or backgrounds, and other data and information about themselves that is entered or gathered by the system (hereinafter “The Career Discovery Engine”). The Career Discovery Engine may also consider the actions or characteristics of previous users of the Career Discovery Engine that have comparable or similar characteristics of the job seeker to consider and/or recommend relevant employment opportunities using information pertaining to these previous users.

This Career Discovery Engine and method goes further, taking data accumulated from such matching, for example, what employers and opportunities are the most popular among the ones matched to individuals in a certain group (e.g. Stanford Economics majors being an example of a group). This system and method may also use what types of individuals have been targeted by certain employers (e.g. a software company targeting potential prospects that belong to certain majors at certain schools). The system and method works to determine what the best matches are, based on the information available to it. A “best match” can be defined as a job or internship that received more views or applications than most of the others that were seen by these individuals. A “best match” can also be defined as an opportunity where the individual was actually hired.

From there, the Career Discovery Engine recommends relevant jobs and internships. Users can then rate the recommendations positively or negatively. They can rate individual attributes of a job such as, but not limited to, an employer, job title, location, job type, industry and/or expected responsibilities of the job. From there, the Career Discovery Engine learns in real time to make individualized recommendations to the users. It also accepts live feedback from other users with similar characteristics and may take this feedback into account and the Career Discovery Engine and method may also base its recommendations, in part, on this information.

The present invention may base its initial recommendations on the above identified factors or characteristics. Moreover, the recommendations provided by the present invention improve in realtime as users interact with the system and provide feedback to the Career Discovery Engine. Additionally, the present invention may use time sensitive information to identify potential career choices, for example, information received within the last three days,

In other words, instead of focusing primarily on the group characteristics (for example the job seeker's major and grade point average at school), the current invention improves the recommendations provided by considering many more characteristics of the job seeker and/or other job seekers with similar characteristics and/or interests. Concurrently, recommendations to other users are also improved by considering the behavior and feedback from one, or more, of the job seekers with similar interests and/or characteristics.

The present invention may also take advantage of machine learning, proprietary data, and/or data mining techniques to provide additional characteristics or preferences that more specifically target the automatic recommendations to assist individuals in deciding what careers and opportunities to pursue in real time, or near real time. The present invention also makes automatic recommendations based on: a) historical data consisting of, but not limited to: employment outcomes (e.g., whether someone received an invitation for an interview, was offered a job, where such data is self reported by the employer or the individual, or extracted from public data about the users, such as a social media profile), b) behavioral data such as what types of individuals apply to certain jobs (taking their school, major, degree and other attributes into account), c) data based on employer targeting of candidates (taking employer industry and other attributes such as employer location and job types into account, and d) the types of candidates they target with attributes such as school, major, degree, technical skills and even softs skills (such as, but not limited to an individual's temperament and their ability to work with other people).

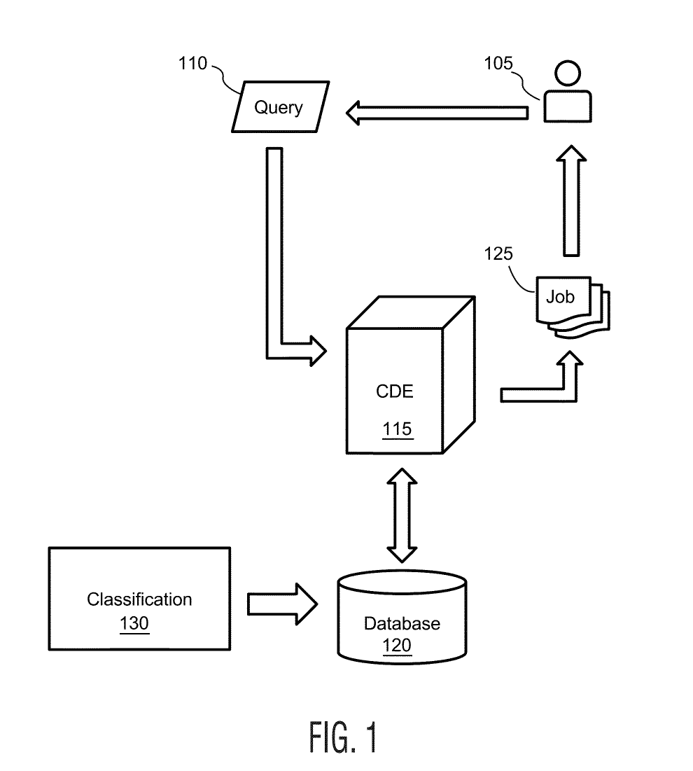

FIG. 1 is a high level diagram of one embodiment including the Career Discovery Engine 100. FIG. 1 includes an individual seeking a job 105, a way of obtaining information from the individual (identified as a Query) 110, the Career Discovery Engine (“CDE”) 115, at least one database 120, information and characteristics of available jobs 125 and a way of introducing new jobs and information into the system (Classification) 130. In one embodiment of the invention, information is obtained from the individual seeking a job 105, through one or more of the following Queries 110: school, major, graduation date, preferences, interviews, questionnaires, evaluations from others, self evaluations, awards, hobbies, and/or feedback from the individual seeking a job 105. Once this information is available to the Career Discovery Engine 115, the Career Discovery Engine 115 analyzes the information to determine one or more characteristics of the job seeker 105 to included in Database 120. The information available in the Career Discovery Engine 115 may be used to match the job seeker 105 to various jobs 125. Job seekers 105 can also assign different factors or weights to different aspects of a job in accordance with how important that job aspect is important to them. For example, a job seeker 105 may weigh the job location higher than a preference for a specific company. In addition, the job seeker 105 may provide feedback on individual jobs and weighing the importance of metadata about the jobs, thereby improving matches between job seekers 105 and jobs 125 made by Career Discovery Engine 115. In addition, as new jobs become available, information regarding those jobs and the desired characteristics of individuals to take those jobs such as, but not limited to, majors based on the classification system are entered into the Career Discovery Engine 115.

In addition, the Career Discovery Engine 115 creates data sets that are then used to make predictions on what jobs are more likely to be of interest to job seekers and to also make predictions on what candidates are more relevant to employers.

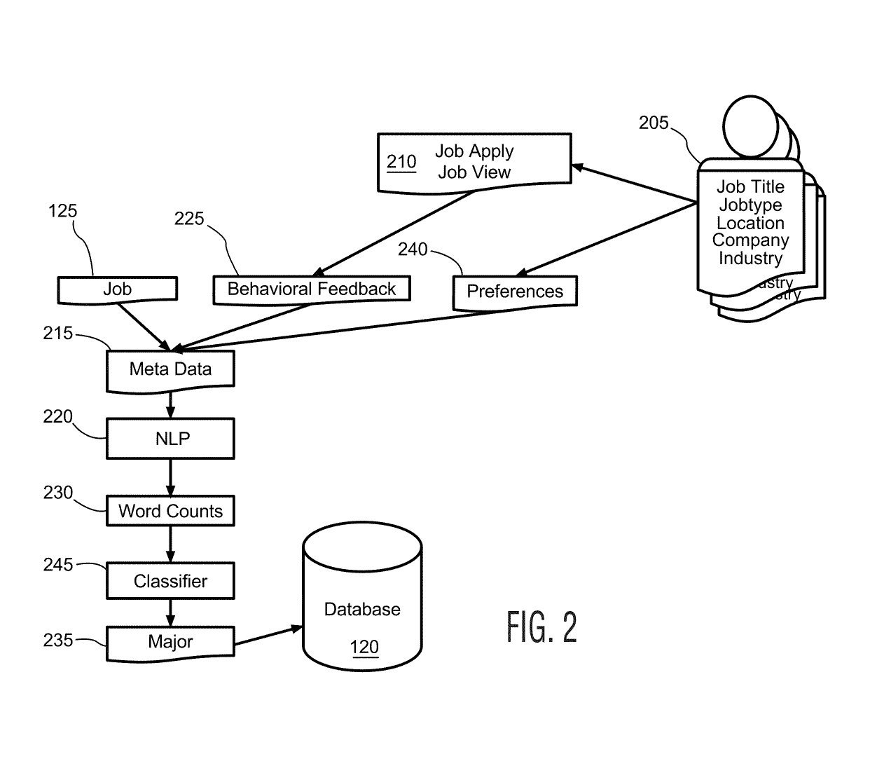

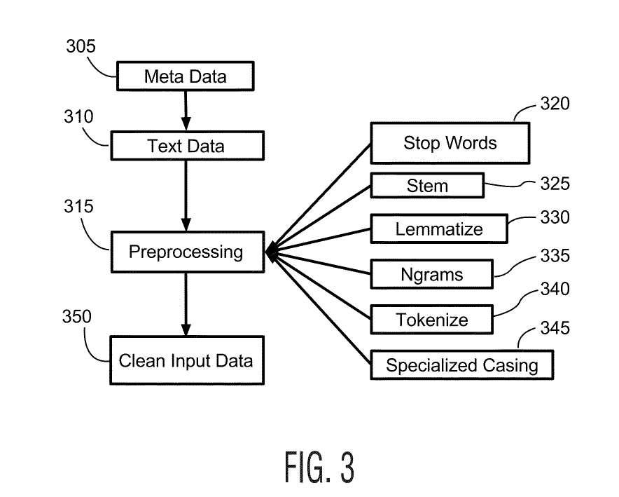

FIG. 2 is a flow chart illustrating a representative algorithm that may be used to implement the present invention. Within the Career Discovery Engine 115, job metadata 205 may be provided to the classification system. Preferably, when a user interacts with a job 125 (for example by viewing it, applying for it, or getting hired by it 210), the Career Discovery Engine 115 may record various aspects of the job (Metadata) 215 such as job title, job location, job type, etc. When this data is grouped by the user's major, for example, the metadata may be broken down into text, processed using Natural Language Processing (“NLP”) techniques 220 (See FIG. 3) and then fed into a classification system such as, without limitation, support vector machines, linear regression machines, etc.

Preferably, user feedback on jobs (likes, dislikes, and other information) 225 is also provided to the classification systems. Preferably, a “windowed” approach is used such that feedback from a predetermined period of time (for example 7 days) is used thereby allowing for unique experiences between users at different times. Jobs may further be tagged based on major or other characteristics and saved in database 120 and later used by the Career Discovery Engine 115 in the process of identifying nontraditional job possibilities for job seekers 105.

Jobs may be classified based on word counts 230, such as the number of times certain words appear in the job description, majors 235, or other characteristics as targets. They may be trained in a one-vs-all fashion to permit multiple outputs, where a job can be labeled with multiple majors or multiple other characteristics. Moreover, jobs may be “hand-picked” as well to add value to certain majors when data is lacking or there are unique jobs that need to be added for specific majors (or other characteristics of interest).

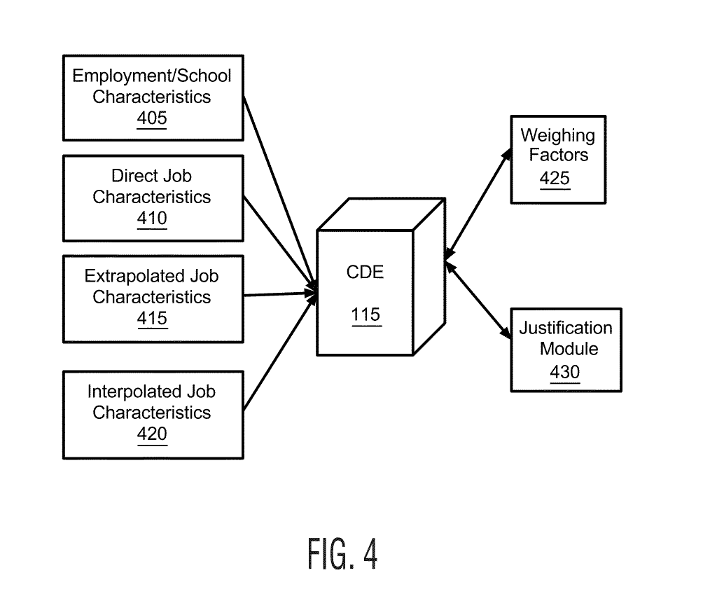

Furthermore, the invention takes user feedback and/or preferences 240 to further improve the recommendations for the specific user and for other users in the system as well. As an example, a user may receive recommendations of jobs or internships based on inputs provided. Inputs can include the user's school, major, degree, outside interests, sports, hobbies, or the like. This can extend to technical skills or soft skill assessment results from tests that users take that can then be entered into this system. Furthermore, such soft skills, outside interest, sports, hobbies or the like may be obtained directly from user input, or by inferring such skills from the user's behaviors, interests, or from other information available. An example of other available information could be a user's social media profile or other available online activity, such as their social media usage. In such a profile, one could look at the user's activities. An activity may be a hobby like cycling. From this activity, one may deduce that the user has endurance, and therefore this can be a characteristic used to recommend jobs, internships or careers. As another example, one can look at the user's extra-curricular activities. If they play on a football or baseball team, the system may deduce that the user is a team player, and this can be another characteristic used in making recommendations to the user, and to other similar users. As an additional example, one can look at the time of day, or night, that a user completes an action on the Career Discovery Engine. If the activity occurs late at night and rarely (or never) in the early morning, the CDE may deduce that the user is a night person versus a morning person. The user's behavior can then be used to further inform and refine future recommendations for the user and for other users who share similar characteristics. The behavior can consist of user feedback in the form of ratings of specific jobs or attributes of said jobs (such as the job title, employer, job type, industry). The behavior can also include, but not be limited to, the length of time spent looking at a job, number of times certain opportunities of a specific location or type or industry are viewed. Such behavior can include voting recommendations up (if they like them), or down (if they dislike them). See FIG. 4. The recommendations automatically update to reflect these preferences, and the recommendations also help inform future recommendations for the user and other similar users.

Classifier 245 is a broad category and may include one or more of a number of different algorithms within it. In the preferred embodiment, Classifier 245 uses Word Counts 230 which are used to create points (i.e., the job content) in an N dimensional space where N is equal to the number of unique words. In addition, a decision function may be used that may create line boundaries within that N dimensional space. In a multilabel case, each point would be labelled as a function of where that point lines with respect to the lines created by the classification. As one of ordinary skill in the art would appreciate, Classifier 245 may include may different techniques or the techniques included in Classifier 245 may be changed in order to maximize the usefulness of the results.

FIG. 3 is a flow chart illustrating a natural language algorithm that may be used to implement the present invention. The Natural Language Processing (“NLP”) 220 begins with meta data 305 (for example, job, feedback, etc.) which is then transformed into text Step 310. The text is then preprocessed using known NLP techniques Steps 320-345. Next, common words and any confusing words based on the current classification category (for example, “Associate” which typically has no value in job title for classification by major) are typically removed in the Stop Words Step 320. Next, within stem 325 and/or lemmatize 330 words are broken down into their common parts of speech wherein the common parts of speech contain the most useful information contained within the words. For example, and without limitation, both Engineering and Engineers may be broken down into Engineer which captures the useful information, while at the same time, minimizing the number of unique words present. In this manner, the Career Discovery Engine 115 is able to build a dictionary of words that will be mapped to the same “key” word leading to both better accuracy and a lower dimensionality of the data. Steps Stem 325 and Lemmatize 330 for normalization of parts of speech and tenses.

In the next step, Step 335, the preprocessing may include determining Ngrams, i.e.,—analyzing job titles to emphasize domain specific matches, (for example, “process engineer” rather than “software engineer”). Specific phrases are then tokenized Step 340, for example “technician” would probably not be indexed alone because it would result in too many matches. In the next step, upper/lowercase tokens Step 345 (Specialized Casing) would be separated to ensure anagrams were given importance. Once the data is processed, the next step in the classification can be undertaken. The resulting output of the Natural Language Processing is Clean Input Data 350.

Unlike skill assessments and traditional career counseling methods, this approach takes live feedback from the user and from other users into account to make relevant recommendations. The user then has the ability to provide live feedback on these recommendations, which automatically updates these recommendations, making the data more timely and relevant to current trends. These recommendations are factored in realtime, and can include all similar individuals in the population, whether these be dozens, hundreds or thousands of users with similar characteristics. Traditional methods and surveys usually have a time delay, in the order of days, weeks or years. The disadvantage of these delays associated with traditional methods is that a survey, for example, of certain individuals who got certain types of jobs may be useful to some extent, but it's based on the past. To further clarify, these past samples could be influenced by historical events, such as the great recession of 2008, which could produce different job and career outcomes for people with certain characteristics compared to the outcomes that would result in more recent times, given the absence of a recession. In other words, the relevant jobs for people with a certain school and major one to five years ago may be different than the jobs those users with the same school and major may obtain in present time, near-present time, or in the future. The ability of the present invention to make its recommendations in realtime (or near real time) and to automatically update these recommendations as appropriate to provide more relevant data to the user that is not outdated. In addition to being a system that improves with the user's real-time feedback, it also takes other similar users' feedback into account to further improve the relevance of the recommendations.

FIG. 4 is a flow chart of example inputs into the Career Discovery Engine. Example inputs into the Career Discovery Engine 115 may include Employment/School Characteristics 405, Direct Job Characteristics 410, Extrapolated Job Characteristics 415, Interpolated Job Characteristics 420, Weighting Factors 425, and a Justification Module 430.

Employment/School Characteristics 405 may include the size of the school, the location of the school, whether the school is located in a large city or not, the facilities of the school, the rating of the school, whether or not the school is an “ivy” league school, and any other characteristic which the Career Discovery Engine 115 may use to determine relevant, or potentially relevant, information regarding the likes, dislikes, and/or preferences of job seeker 105.

Direct Job Characteristics 410 may include size of company office job seeker 105 worked in, the location of the company office the job seeker worked in, whether the company office the job seeker worked in was located in a large city or not, the facilities located at the office the job seeker worked at, the strengths and/or weaknesses of the company, and any other characteristics which the Career Discovery Engine may use to determine relevant, or potentially relevant information regarding the likes, dislikes, and/or preferences of the job seeker 105.

Extrapolated Job Characteristics 415 are job characteristics which are extrapolated by the Career Discovery Engine 115 from the data provided to it. If the Career Discovery Engine 115 is provided with data regarding a job seeker 105 that allows the Career Discovery Engine 115 to make a reasonable assumption regarding the job seeker 105, but the assumption is not directly supported by the data, the assumption would be determined by the Extrapolated Job Characteristics 415. For example, and without limitation, suppose job seeker 105 enjoyed betting on horse races, enjoyed sports and indicated it was important for him to be able to attend live sporting events on which he could place bets on, but job seeker 105 had never witnessed a Jai Alai game. The Career Discovery Engine 115 may not be able to determine with absolute certainty that living and working near a location where Jai Alai would meet the job seeker's desire to attend live sporting events which he could bet on, but the Career Discovery Engine 115 could reasonably deduce (extrapolate the answer) that living and working near a location where Jai Alia games were played would meet job seeker's interests.

Alternatively, Interpolated Job Characteristics 420 are characteristics the Career Discovery Engine 115 could determine with reasonable certainty that job seeker 105 would enjoy. For example, and without limitation, suppose job seeker went to college in a city that had a professional football team and took a first job in a city that had a professional football team. Assume furthermore that this particular job seeker 105 said that she enjoyed attending professional football team events two or three times each season. In this case, Career Discovery Engine 115 could conclude that living and working in a city that has a professional football team would be of particular importance to this specific job seeker 105.

One of ordinary skill in the art would appreciate that Weighing Factors 425 is the weight, or importance, that the Career Discovery Engine 115 would place on other characteristics. For example, and without limitation, if a job seeker 105 specified that he/she wanted to live within 30 miles of an ocean and this was the most important factor in his/her considerations for accepting a position with a new employer, the Career Discovery Engine 115 may ensure that each position provided to this job seeker for review was located within 30 miles of an ocean. Conversely, if a different job seeker 105 indicated that living within 30 miles of an ocean was desirable, but not necessary, the Career Discovery Engine 115 would assign a lower weight (or preference) to a “living near an ocean” factor to this second job seeker than it did to the first job seeker.

Justification Module 430 may provide the job seeker 105 with a mathematical justification for the positions identified by the Career Discovery Engine 115 for this specific job seeker. For example, and without limitation, for each position identified by the Career Discovery Engine 115 for a specific job seeker 105, the Career Discovery Engine may provide the job seeker 105 with a listing of the factors considered in identifying that position, how each factor was weighted and any other considerations used to identify each position identified by the Career Discovery Engine 115 for consideration. For example, and without limitation, if Career Discovery Engine 115 identified an entry level economist position at the International Monetary Fund (“IMF”) in Washington D.C. for a finance major from Stanford, the job seeker could review each factor, and the weight each factor was assigned, that recommendation was based on. The factors considered may include salary, working for an international organization, tax benefits, living within 3 hours of an ocean, living in a city that has a professional football and baseball team, the job seeker's membership in a team sport, positions offered by the IMF to other job seekers with similar characteristics, the job seeker's possession of numerous characteristics the IMF has identified for successful employees, and any other factors considered relevant by the Career Discovery Engine 115 and the weights each of these factors were assigned during the pairing of this specific job seeker with that economist position at the IMF. By reviewing the results provided by the Justification Module 430, the job seeker can determine why this position was offered to him or her and can adjust the factors or the weights assigned to each of those factors to have the Career Discovery Engine 115 make better matching between available positions and this specific job seeker.

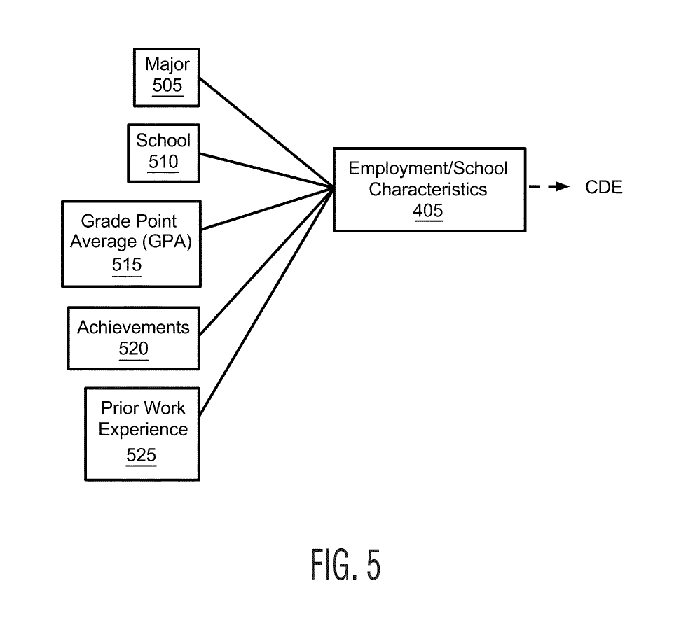

FIG. 5 is a flow chart for the identification of Employment/School Characteristics 405. The characteristics that may be considered include, but are not limited to, Major 505, School 510, Grade Point Average (GPA) 515, Academic Achievements 520, and/or Prior Work Experience 525. Many of these characteristics may be considered by current Career Development Tools or Services. Major 505 may include any majors the job seeker has, or had while in college and may include multiple majors while in one specific school or various majors while in several different schools. School 510 may include any school job seeker 105 is currently attending or has attended in the past. School 510 may also include any additional schools job seeker 105 was accepted by. Grade Point Average (GPA) 515 may include the job seeker's current grade point average at his/her current school, previous grade point averages at one or more schools the job seeker 105 previously attended, or both. Academic Achievements 520 may include any academic achievements that job seeker has received at his/her current school or any previous school. Prior Work Experience 525 may include any work experience job seeker 105 currently has or has had and may include job title, job duties, duration of job, stop and start hours, portions of the job that were of special interest to the job seeker, portions of the job that job seeker would rather not have had to perform, and any other characteristics of that job (or those jobs) that the job seeker may provide that may assist the Career Discovery Engine 115 in identifying other potential employment opportunities for the job seeker 105.

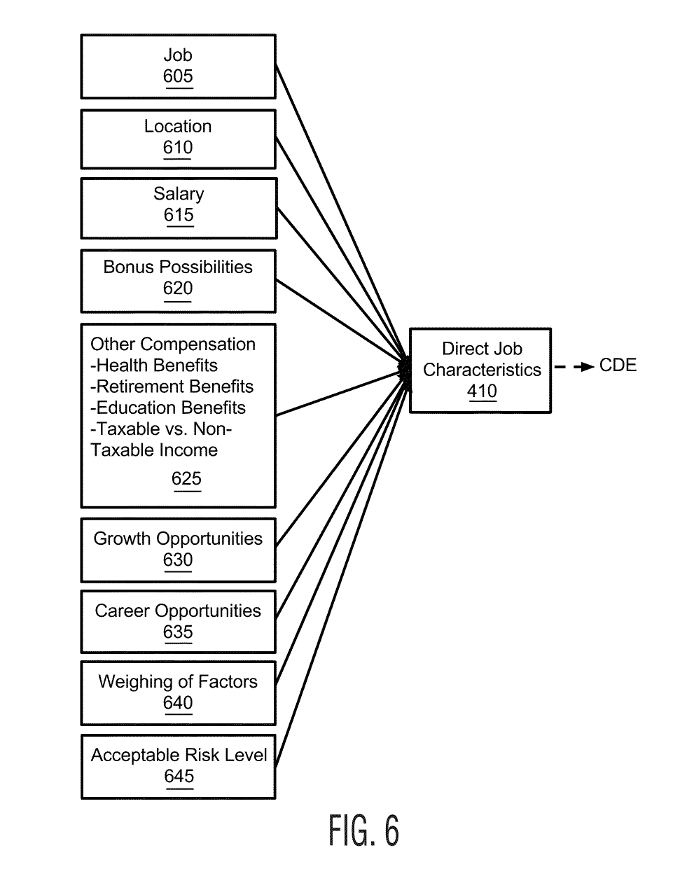

FIG. 6 is a flow chart for the identification of Direct Job Characteristics 410. The characteristics that may be considered include, but are not limited to, Job 605, Location 610, Salary 615, Bonus Possibilities 620, Other Types of Compensation 625, Growth Opportunities 630, Career Opportunities 635, Weighing of Factors 640, and/or Acceptable Risk Factors 645. Job 605 may be provided to the Career Discovery Engine by job title, a description of job responsibilities the job seeker desires, a description of job responsibilities the job seeker wishes to avoid, job codes, or field. Location 610 may be provided to the Career Discovery Engine by city, state, region of the United States, acceptable temperature ranges, acceptable levels of sunshine, location of nearby attractions, such as amusement parks, beaches, lakes, etc., or similar search criteria that the job seeker wishes to avoid. For example, if a specific job seeker is concerned about tidal waves, they may not wish to be presented with any job opportunities within 200 miles (for example) of a beach. As a second example, if a specific job seeker enjoys sushi, they may only wish to be presented with job opportunities within 25 miles of an ocean. Similarly, if a specific job seeker is an avid surfboarder, they may only wish to be presented with job opportunities within 30 miles of a beach which is rated within the top five beaches for surfing in the United States. Moreover, this Career Discovery Engine 115 may update this information in real time, or near real time. For example, and without limitation, if two different individuals interested in surfing use the Career Discover Engine 115 to search for jobs within 30 miles of a beach which is rated within the top five beaches for surfing in the United States, the specific beaches identified by the Career Discovery Engine 115 may be different, for example, because a top rated surfing magazine or Internet site rerated the top rated surfing beaches between the time the first job seeker and the second job seeker sought job opportunities.

Salary 615 may also be provided to the Career Discovery Engine 115 in a number of different ways, for example as a gross dollar earned amount, as an after tax dollar amount, as a maximum amount over the cost of living at that location amount, as a maximum amount over the average U.S. income amount, or in any other way specified. Bonus Possibilities 620 may be provided to the Career Discovery Engine 115 in a variety of ways from no bonus possible, to a bonus as a percentage of base salary, to a bonus as a multiple of a base salary, to bonuses dependent on meeting various sales quotas or other bonus qualifying characteristics. Other Compensation 625 may be provided to the Career Discovery Engine in a variety of ways, including, but not limited to, health benefits, retirement benefits, education benefits, taxable vs nontaxable income, allowance for mileage, allowances for per diem expected during business travel, travel opportunities or demands, of any other job related factors of the various job opportunities provided by the Career Discovery Engine 115. Moreover, Salary 615, Bonus Possibilities 620, and Other Compensation 625 may be combined into a single Overall Compensation category which combines each of the possible sources of compensation to the job seeker for an overall assessment of the possible compensation. Moreover, an Overall Compensation category may also present the job seeker with an assessment of, for example, the lowest overall compensation, the highest overall compensation, various probabilities for various levels of compensation, and/or one or more charts showing the various levels of possible overall compensation with the requirements that need to be met by the job seeker to achieve one or more of the various overall compensation possibilities. Growth Opportunities may also be provided to the Career Discovery Engine 115 as those desired by the job seeker, or those available within each of the jobs presented to the job seeker, or both. Growth Opportunities 630 may include areas of advancement, or additional job opportunities that may be available to the job seeker if the job seeker took advantage of various educational or vocational opportunities. Career Opportunities 635 may include areas of advancement or additional job opportunities within the present career of the job seeker. For example, if the job seeker currently was employed as a systems engineer, Career Opportunities 635 would present opportunities for advancement for the job seeker as a system engineer, but not opportunities for advancement as an economist or an administrator. Weighing of Factors 640 preferably would permit the job seeker 105 to provide various weighing factors to the Career Discovery Engine 115 to represent the importance of the various job characteristics to the job seeker 105. For example, a specific job seeker 105, may prioritize salary as the most important characteristic, and may only wish to review the most lucrative job opportunities available to him/her. Alternatively, a different job seeker, may determine that their interest in spelunking (cave exploring) is more important to them than obtaining a salary over a predetermined amount, any may place more emphasis on the job location, once a minimum salary is available. In that case, the Career Discovery Engine 115 may require the job seeker's minimum salary, but once that minimum salary was available, the Career Discovery Engine 115 would adjust the weight of the various factors to place more emphasis on a location of the country which is more desirable from a “spelunking” point of view.

Acceptable Risk Level 645 may include a myriad of possibilities, from various risks a job seeker is willing to take with respect to their salaries, their health, or the possibility of finding a “significant other” in specific job locations. “Risk Taking” job seekers, may prefer to review job opportunities with lower base salaries when the potential bonus, say for example for meeting a predetermined sales quota, are lucrative. Other job seekers may be willing to be exposed to less desirable working conditions for higher pay for a certain amount of time—for example, they may be willing to work in a nuclear power plant for several years resulting in a high wage with the understanding that there may be a risk of exposure to hazardous radiation. The result of job seeker providing this information to the Career Discovery Engine 115 is that the Career Discovery Engine determines a number of Direct Job Characteristics of interest to the job seeker, or on the other hand, a number of Direct Job Characteristics the job seeker wishes to avoid, or preferably, a number of Direct Job Characteristics of interest to the job seeker and a number of Direct Job Characteristics the job seeker wishes to avoid. These Direct Job Characteristics are provided by the Direct Job Characteristics Module to the Career Discovery Engine 115.

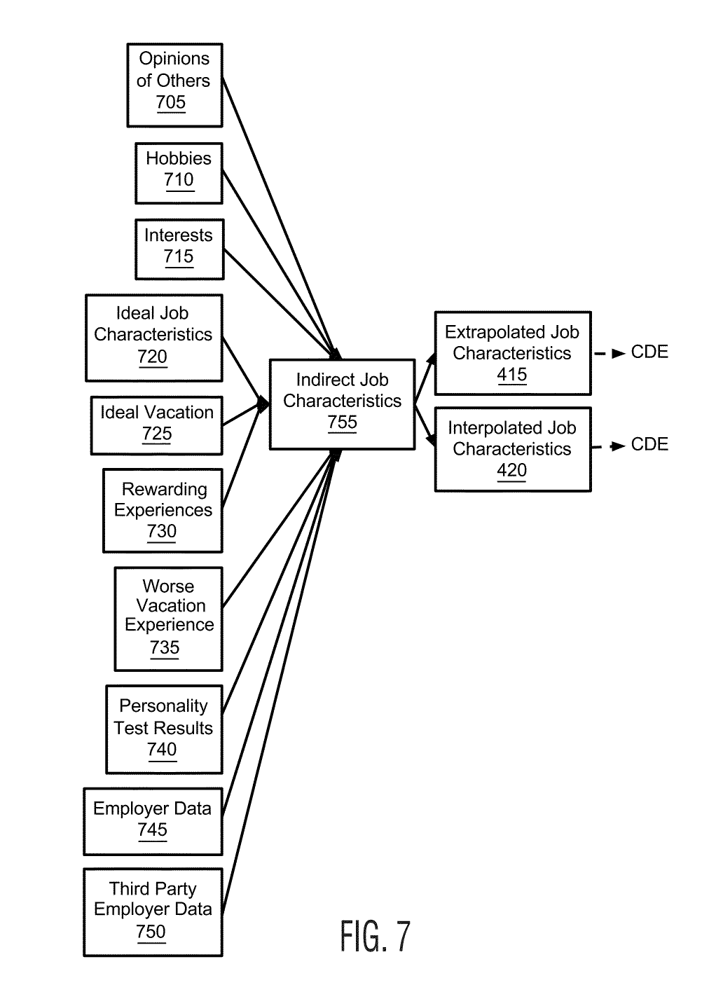

FIG. 7 is a flow chart for the identification of Extrapolated 415 and Interpolated Job Characteristics 420. The characteristics that may be considered include, without limitation, Opinions of Others 705, Hobbies 710, Interests 715, Ideal Job Characteristics 720, Ideal Vacation 725, Rewarding Experiences 730, Worst Vacation Experience 735, Personality Test Results 740, Employer Data 745, and Third Party Employer Data 750. Opinions of Others 705 may also be provided to the Career Discovery Engine 115 in a number of different ways, including, without limitation, evaluations from individuals who are familiar with the job seeker, previous employers of the job seeker, individuals who taught the job seeker at school, guidance counselors, faculty staff, graduate students, coworkers, or basically, anyone who is familiar with the job seeker who can be relied upon to give an honest and candid appraisal of the job seeker including, but not limited to the strengths, weaknesses, and qualities of the job seeker. Hobbies 710 (i.e., hobbies of the job seeker) may also be provided to the Career Discovery Engine 115 by the job seeker, or by individuals who are familiar with the job seeker and the Career Discovery Engine 115 may use characteristics common of individuals who participate in those hobbies to assist in the determination of appropriate job opportunities for the job seeker. For example, if an individual enjoys hiking the national parks, the Career Discovery Engine 115 may associate this hobby with characteristics of an individual who is motivated, able to work alone, one who derives a sense of accomplishment from individual achievements and one who enjoys the outdoors. As a second example, if the job seeker enjoys participation in skydiving, the Career Discovery Engine 115 may associate this hobby with characteristics of an individual who enjoys taking chances and participating in high risk activities. Interests 715 may also be provided to the Career Discovery Engine 115 through the self evaluation or reporting of the job seeker or others familiar with the job seekers' interests. The Career Discovery Engine 115 may associate these interests with various characteristics of individuals and may factor these considerations into the identification of potential job opportunities for the job seeker. Ideal Job Characteristics 720 are preferably reported or identified by the job seeker him/herself. Similarly, Ideal Vacation 725, Rewarding Experiences 730, Worst Vacation Experience 735, and Personality Test Results 740 may all be used by the Career Discovery Engine 115 to identify or eliminate various characteristics that may be used to assist the Career Discovery Engine 115 to identify potential career choices for the job seeker. Employer Data 745 may include information from Employers who are affiliated with the Career Discovery Engine 115, or other companies that share relevant data, and may include information on characteristics that the employers have determined are successful traits for various careers. For example, and without limitation, if several employers have determined that coin collecting is a hobby of successful accountants, the Career Discovery Engine 115 would create an association between coin collecting and accountants and that association may be used to present accounting careers or jobs to future job seekers that identify coin collecting as one of their hobbies or interests. Similarly, Employer Data 745 and Third Party Employer Data 750 may include information on relationships or associations between Opinions of Others 705, Hobbies 710, Interests 715, Ideal Job Characteristics 720, Ideal Vacations 725, Rewarding Experiences 730, Worst Vacation Experiences 735, and/or Personality Test Results 740 that may be used by the Career Discovery Engine 115 to identify potential nontraditional matches between job opportunities and job seekers.

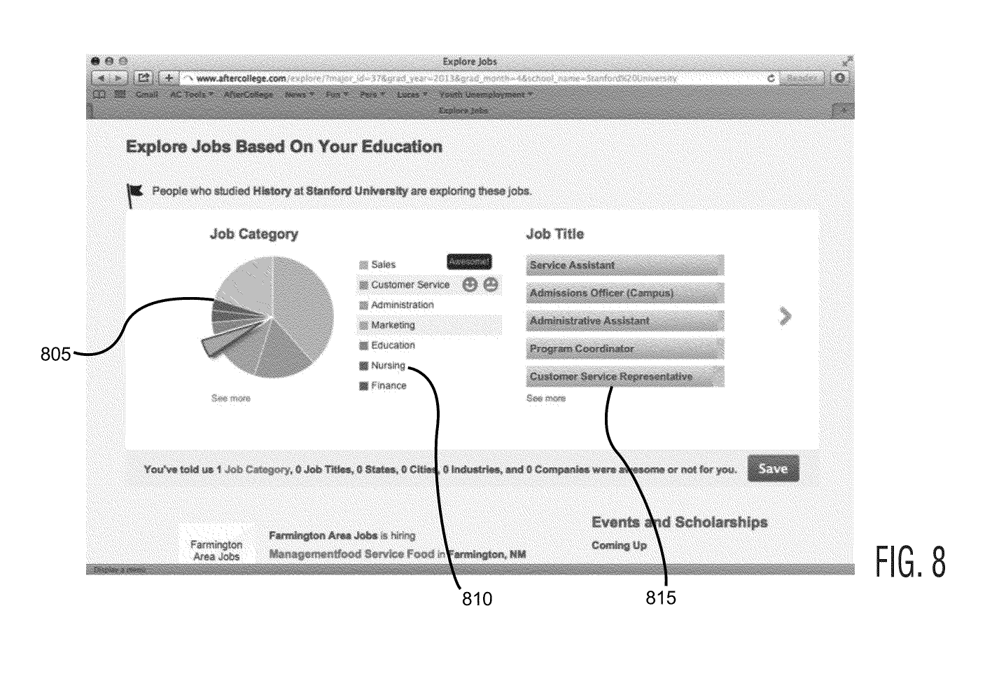

FIG. 8 is a screen capture of an example embodiment of the invention in which the career discovery tool takes user provided characteristics to make job and internship recommendations that are then rated by the user, further improving the recommendations for said user and other similar users in real time. In this example, the job seeker 105, (a history major at Stanford University) is presented with a pie chart 805 showing what jobs other history majors from Stanford University are exploring. FIG. 8 shows that individuals who majored in history from Stanford University are exploring positions in sales, customer service, administration, marketing, education, nursing, and finance 810. In addition, the pie chart of FIG. 8 also provides the job seeker with the numbers of individuals who majored in history at Stanford University are seeking these different career paths. In addition, FIG. 8 also presents the job seeker 105 with various job titles individuals with history majors from Stanford University are considering 815.

The present invention does more than automate processes which otherwise would be involved in collecting such feedback manually, which is time consuming and it creates a time delay in the relevance of the recommendations. In addition, the present invention uses nontraditional job search information and the properties or characteristics of this information to improve the matching process between the job seeker and the identified fields or specific jobs opportunities.

Traditional methods may also prove outdated for jobs that did not exist before. As an example of new jobs being created, we are now close to having self-driving cars. The people who maintain and test these new self-driving cars may require new skills and have job titles that did not exists before. This system allows for the rollout of new job data, have users review those jobs, and provide feedback in realtime, thus creating a reference point to be able to recommend said jobs to relevant individuals based on the live feedback being collected.

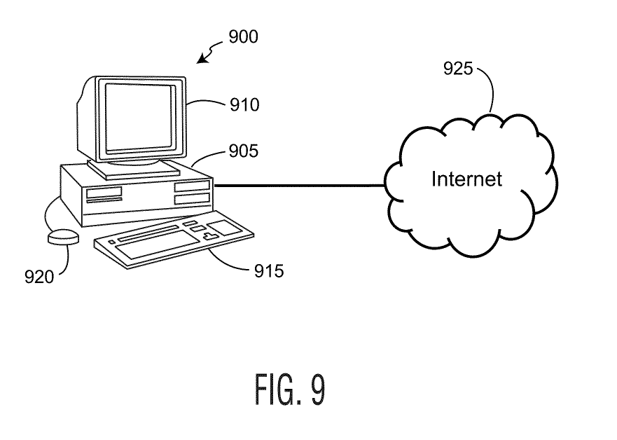

FIG. 9 shows a representative computer system 900 that may be used to implement the current invention. Computer system 900 includes the computer 905 which houses a processor, memory, a computer display 310 as an output device, and input devices such as a keyboard 915 and a mouse 920. The memory of the computer system 900 may be used to store the database. The processor of the computer 905 may be used to analyze the data accumulated on the job seeker and to perform comparisons between data stored in the database or other data accessible to the computer system. The computer system may also be connected to the Internet as a source for information.

In addition to the above application of the invention, this method can be used to help individuals discover not only careers and employment opportunities, but also relevant fields of study, courses to take, and potentially organizations where they should conduct their studies, based on where other similar users have had success.

Advantages of the proposed invention include, but are not limited to: (1) Automatic real-time improved recommendations based on user and other similar user feedback, (2) Job recommendations are targeted on individual preferences and feedback such as location, prestige of employers, salary, and other attributes, (3) recommendations take non-traditional characteristics into account such as a user's attributes related to hobbies and extra-curricular activities and (4) Recommendations are also targeted based on behavior such as time on a page or frequency of visit or any other identifiable behavior, for example, the amount of feedback given on a certain attribute of a job such as its location vs. the job title or the job type.

1. A method of identifying career opportunities for a first and a second job seeker comprising:
gathering desired characteristics common to individuals in at least a first and a second career choices from at least one employer;
gathering information concerning individuals currently working in said first career choice and using said information to determine characteristics of individuals in said first career choice;
gathering information concerning individuals currently working in said second career choice and using said information to determine characteristics of individuals in said second career choice;
gathering first information from said first job seeker;
obtaining first priority information from said first job seeker regarding the personal importance of various job characteristics;
gathering second information from said second job seeker;
obtaining second priority information from said second job seeker regarding the personal importance of various job characteristics;
determining at least two characteristics of said first job seeker from information gathered concerning said first job seeker;
determining a relative importance of said at least two characteristics of said first job seeker;
determining at least two characteristics of said second job seeker from information gathered concerning said second job seeker;
determining a relative importance of said at least two characteristics of said second job seeker;
storing (a) said first and second career choices, (b) desired characteristics common to individuals in at least said first and second career choices, (c) said first priority information from said first job seeker, and (d) said second priority information from said second job seeker; in a database;
searching said database using said at least two characteristics of said first job seeker to identify a possible career choice; and
presenting said career choice to said first job seeker.

2. The method of claim 1 further including:
calculating a justification for said career choice presented to said first job seeker wherein said justification uses at least first priority information from said first job seeker, information regarding said first job seeker, and the at least two characteristics of said first job seeker; and
presenting said justification to said first job seeker to explain how the possible career choice was determined.

3. The method of claim 1 wherein one of said at least two characteristics of said first job seeker includes an extrapolated job characteristic.

4. The method of claim 1 wherein one of said at least two characteristics of said first job seeker includes an interpolated job characteristic.

5. The method of claim 1 wherein said information concerning said first job seeker is on the hobbies of said first job seeker.

6. The method of claim 1 wherein said information concerning said first job seeker is on the ideal vacation of said first job seeker.

7. The method of claim 1 wherein said information concerning said first job seeker is on the worst vacation experience reported by said first job seeker.

8. The method of claim 1 further including gathering first additional information regarding said first job seeker from at least one other person who has first additional information regarding said first job seeker.

9. The method of claim 8 further including gathering second additional information regarding said second job seeker from at least another individual who has second additional information regarding said second job seeker.

10. The method of claim 1 further including identifying at least one trend in said first or second career choice and using said trend to identify said possible career choice to said first or second job seeker.

11. The method of claim 1 further including using including time sensitive information in said database and using said time sensitive information to identify said possible career choice for said first job seeker.

12. The method of claim 11 wherein said time sensitive information is less than 72 hours old.

13. The method of claim 1 wherein said individual providing information concerning individuals currently working in said first career choice is working in said first career choice.

14. The method of claim 1 wherein said individual providing information concerning individuals currently working in said second career choice is working in said second career choice.

15. A Career Discovery Engine used for identifying career opportunities to a job seeker comprising:
a first input device to gather first information from a first job seeker;
a processor programmed to obtain first priority information from said first job seeker regarding the personal importance of various job characteristics;
a second input device to gather first additional information regarding said first job seeker from at least one other person who has first additional information regarding said first job seeker;
said processor programmed to determine at least two characteristics of said first job seeker from information gathered concerning said first job seeker;
said processor programmed to determine a relative importance of said at least two characteristics of said first job seeker;
a comparator for comparing desired characteristics of said career choices with characteristics of said first job seeker to identify a possible career choice for said first job seeker; and
an output device to present said possible career choice to said first job seeker.

16. The Career Discovery Engine of claim 15 wherein said processor is also programmed to calculate a justification for said possible career choice presented to said first job seeker and said output device is also used to present said justification to said first job seeker to explain how the possible career choice was determined.

17. A Career Discovery Engine used for identifying career opportunities to a job seeker comprising:
a first input device to gather first information from a first job seeker;
a processor programmed to obtain first priority information from said first job seeker regarding the personal importance of various job characteristics;
a second input device to gather first additional information regarding said first job seeker from at least one other person who has first additional information regarding said first job seeker;
said processor programmed to determine at least two characteristics of said first job seeker from information gathered concerning said first job seeker;
said processor programmed to determine a relative importance of said at least two characteristics of said first job seeker;
a comparator for comparing desired characteristics of said career choices with characteristics of said first job seeker to identify a possible career choice for said first job seeker;
an output device to present said possible career choice to said first job seeker;
said processor programmed to calculate a justification for said possible career choice presented to said first job seeker wherein said justification uses at least first priority information from said first job seeker, information regarding said first job seeker, and the at least two characteristics of said first job seeker; and
wherein said output device to present said justification to said first job seeker to explain how the possible career choice was determined.
